(19) United States
(12) Patent Application Publication
(10) Pub. No.: US 2009/0020360 A1
(43) Pub. Date: Jan. 22, 2009

(54) LANDING LADDER

(76) Inventor: Brian A. May, Greenwood, MO (US)

Correspondence Address: HUSCH BLACKWELL SANDERS LLP, 4801 Main Street, Suite 1000, KANSAS CITY, MO, 64112, US

(21) Appl. No.: 11/779,375

(22) Filed: Jul. 18, 2007

(51) Int. Cl. E06C 1/38

(52) U.S. Cl. 182/1

(57) ABSTRACT

The present invention involves a selectively collapsible ladder which permits for adjusting the pitch of the steps between at least two pitches, one pitch being where the ladder collapsed for storage and another pitch whereby the steps are positioned for use by a user. The ladder includes a support structure comprising one or more support rails for extending between the ground and a loading or work surface or storage compartment. The steps are connected together by one or more links for effecting simultaneous movement of the steps. A stop mechanism is provided to releasably fix the step pitch relative to a support rail. The stop mechanism may include a ratchet mechanism that permits setting the pitch of the steps at one of several available pitch settings.

### BACKGROUND OF INVENTION

In the operation of trucks and other vehicles, the use of a ladder therewith may be needed for the effective operation of the vehicle. Such vehicles may include trucks used for hauling goods or items, service vehicles, emergency vehicles e.g., fire trucks and emergency medical treatment vehicles. Such ladders are useful in assisting in loading and unloading items from a truck or obtaining access to various regions in a fire truck, ambulance or the like. The landing, door or other area of the vehicle that needs access is not always at the same height above the ground often times because of terrain or there may be multiple areas on a single vehicle that need accessed. This presents problems with ladders having deep treads or steps since the treads or steps will not necessarily be at the correct and preferably level pitch. One solution to this problem is the use of ladders with rungs that have a small depth so that the out of pitch condition is not noticeable. Additionally, such ladders may have curved upper surfaces for engagement with a user's foot so that any out of pitch condition is not noticed. Small depth and curved contact surfaces can cause user discomfort.

These solutions, however, have not been acceptable particularly when the ladder is to be used where deep treads are desirable for user comfort and stability. It would also be desirable to have a ladder with adjustable pitch steps which pitch does not depend on the surface on which the ladder rests. Additionally, it would be desirable to have a ladder adapted for adjusting the working height by adjusting the angularity of the ladder relative to the device on which the ladder is resting while providing a user adjustable pitch step.

### SUMMARY OF INVENTION

The present invention involves the provision of a collapsible ladder having adjustable pitch steps with at least one use pitch. The ladder includes at least one back rail connected to the steps which steps can selectively pivot relative to the back rail. At least one link is connected to the steps to help simultaneous pivoting movement of the steps relative to the back rail. A base is provided for engaging the ground and the base spans a substantial distance on the ground for stability. A stop mechanism is provided and is operably associated with the link and or steps to selectively limit movement of steps relative to the back rail to fix the pitch of the steps. The stop mechanism may include a ratchet mechanism and/or fixed stops. One or more spacers may also be provided to provide for a space between the link and the back rail to eliminate a pinch point.

### BRIEF DESCRIPTION OF DRAWINGS

FIG. 1 is a front perspective view of a collapsible ladder showing the ladder in a collapsed configuration.

FIG. 2 is a perspective view of a preferred embodiment of the ladder with the ladder shown resting on a portion of a vehicle.

FIG. 3 is an enlarged fragmentary perspective view of a portion of the ladder showing the steps in a collapsed configuration for storage.

FIG. 4 is an enlarged side fragmentary view of a ratchet mechanism and step with the step latched in a collapsed configuration.

FIG. 5 is an enlarged side fragmentary view of the ladder of FIG. 4 with the step latched in a first use position

FIG. 6 is an enlarged side fragmentary view similar to FIG. 5 but showing the step in a second use position.

The same number used throughout the various figures designates like or similar parts and/or structure as described herein.

### DETAILED DESCRIPTION

The reference numeral 1 designates generally a ladder for use with a vehicle or other device such as a landing 2 which may be part of a vehicle. The ladder 1 is useful with any vehicle, e.g., a vehicle used for transporting and distributing goods or items, an emergency vehicle such as a fire truck or an ambulance, a maintenance or service truck or the like, where on occasion, a user needs to move to an elevated position to perform acts such as loading and unloading, accessing supplies, equipment and the like. The ladder 1 includes a plurality of steps or treads 4 that are supported by a suitable support structure 5 permitting pivoting movement of the steps 4 on the support structure. The support structure 5, in the illustrated embodiment, includes at least one back rail 7 and at least one link 8 each connected to each of the steps 4. A landing (not shown) may also be provided as part of the ladder 1, if desired, which would be particularly useful when the ladder 1 is to be used for loading and unloading items. The support structure 5 also provides the ladder with a base 10 for engaging the ground. The width of the base 10 spans a sufficient distance to provide stability for the ladder. A stop mechanism 14 is also provided which releasably fixes the steps 4 for use in at least one and preferably more than one pitch independent of the angle of the ground on which the ladder 1 rests. Preferably, the stop mechanism 14 provides for a plurality of fixed use pitches.

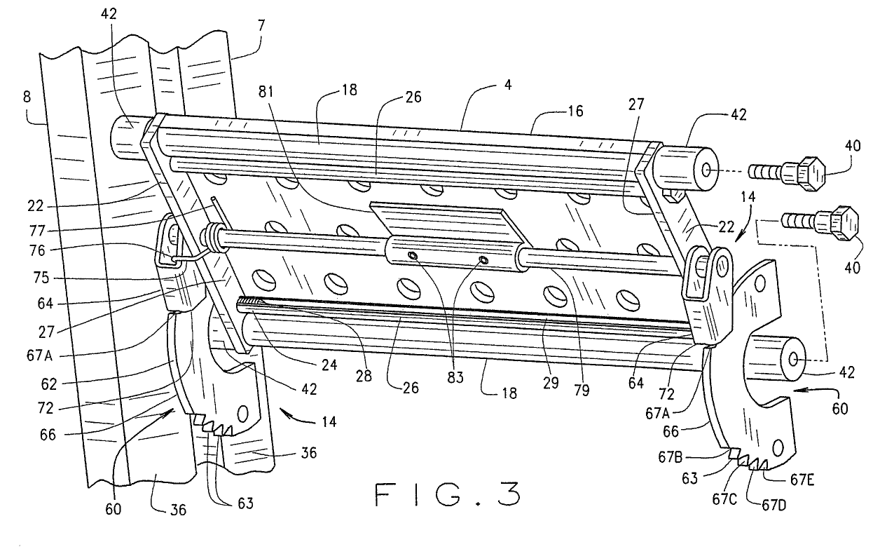

In the illustrated structure, the ladder 1 includes a plurality of vertically spaced apart steps 4. The description of the ladder 1 herein, unless otherwise specified, is for the ladder being positioned in a use configuration with one end portion resting on the ground and another end portion being supported by a vehicle or loading platform. As shown, the steps 4 have a width “W” and a depth “D.” The steps 4 will have a tread plate 16 that is preferably generally planar on the upper surface and may be provided with plurality of traction enhancing members such as holes, raised diamond patterns, ribs and the like. Preferably the steps 4 are made of an aluminum alloy material for lightness and strength. To provide for strength, without excessive use of material, the moment of inertia of the tread plate 16 may be increased by providing a web structure which is shown as including front and rear web members 18 which may be formed with the tread plate. The tread plate 16 and members 18 may be at least partially formed as by extrusion. Opposite ends of the steps 4 may be provided with additional support members 22 which may be secured to the tread plate 16 as by welding. The steps 4 may also be formed by casting. The supports 22 may be secured to the tread plates 16 as with a screw fastener arrangements 24. The steps 4 have front-to-rear spaced channels 26 that are preferably an integral part of members 18. As best seen in FIG. 3, the supports 22 may be secured to the tread plate 16 with channel members 26 extending between interior faces 27 of the supports 22 which can be fastened in place with screw fasteners 28 extending through the supports 22 and into the channel members 26. The channel members 26 may have an open side 29 which will permit for expansion of the channel members 26 during installation of the screw fasteners 28. The end faces of the web members 18 help secure the supports 22 in perpendicular relationship to the treads 16.

The ladder 1 includes a step support structure 5. The step support structure 5 includes at least one rail 7 and at least one link 8. The steps 4 are pivotally attached to the rail 7 and the link 8. The rail 7 provides for load bearing support and the link 8 provides for simultaneous adjustment of the pitch of the steps 4. A base 10 is also provided as part of the support structure 5 and preferably spans a distance to be outside of the normal stepping area of the steps 4 which is preferably at least about one half of the width W of the steps 4 to provide for a reduction in any outside lateral loading moment about the mounting of the steps to the support structure. It is to be understood that a single rail and a single link can be used. However, it is preferred that the support structure 5 includes a pair of spaced apart rails 7 and a pair of spaced apart links 8. In a preferred embodiment, the rails 7 and the links 8 are aluminum alloy or composite material such as fiberglass U channels. A U channel shape provides for convenience in assembly of the steps 4 to the rails 7 and links 8. In the illustrated structure, the base 10 is provided for by the lower end portions 32 of the rails 7 which are held in spaced apart relationship by the steps 4. If a single rail 7 is used, a U-shaped lower leg structure may be used to provide a wide foot print for stability.

The steps 4 are pivotally mounted to the support structure 5. As shown, the steps 4 have fasteners 40 such as shoulder bolts or studs secured thereto that are each received through a respective aperture in the web 36 of the U-channels forming the rails 7 and links 8. By having U-channels, a recess 38 is provided which allows for shielded securement of the fasteners 40. As seen, friction reducing spacers 42 are provided on the fasteners 40 to space the rails 7 and links 8 from the side edges of the steps 4 to provide for clearance for the fasteners 40. The steps 4 and the rails 7 and the links 8 on each side form a parallelogram arrangement of parts such that when the links 8 are moved, they remain in an orientation that is generally parallel to the longitudinal axes of the rails 7. During movement of the links 8, the links will either move toward or away from the rails 7 narrowing or widening the gap 44 therebetween. Spacers or stops 45 may be secured to either the rails 7 or links 8 to limit movement of the links and rails toward one another so that the gap 44 is wide enough to prevent finger pinching where the ladder 1 is collapsed. Movement of one step 4 or one link 8 will effect simultaneous movement of the other link 8 and steps. The links 8 have opposite ends 46, 47 with end 46 being a top end and the other end 47 being a bottom end. The bottom ends 47 of the links 8, in a preferred embodiment, do not touch the ground but are retained in an elevated position relative to the ground during ladder use. The bottom ends 32, 47 of the rails 7 and the links 8, respectively, may be provided with an end cap member 50, for example, a curved foot to provide for good contact with the ground and/or prevent contact of a sharp edge of the end with a user. Often times, such feet are made of a polymeric material and are either fastened with mechanical fasteners, press fit or adhesively joined to a rail or link.

The ladder 1 is provided with a stop mechanism 14 that will selectively limit at least opening movement of the steps 4 and links 8. Preferably the stop mechanism 14 is operable for fixing the ladder in at least one of a plurality of selectable open configurations. Further, the stop mechanism14 is operable to selectively retain the steps 4 and links 8 in a closed configuration for storage and to prevent unintended movement of the links and steps during movement of the ladder from a collapsed configuration to an extended use configuration. The stop mechanism 14 is operably associated with the links or one of the steps to selectively limit movement of the steps 4 relative to the rail 7 to selectively fix the pitch of the steps at a desired pitch. The stop mechanism 14 is preferably operated manually by the user of the ladder 1.

As seen in FIG. 3, the stop mechanism 14 includes at least one ratchet mechanism 60 preferably associated with at least one of the rails 7 and at least one of the steps 4 to selectively fix the pitch of the steps relative to the rail and the ground. In the illustrated structure, the ratchet mechanism 60 includes a ratchet wheel 62 having a plurality of spaced apart teeth 63 for engagement with a pawl 64. The wheel 62 is shown as having a generally circular edge 66, however, the wheel can have a curved exterior edge. As shown, the ratchet wheel 62 has a generally circular exterior ratchet surface with a plurality of notches 67 therein. In a preferred embodiment a pair of ratchet mechanisms 60 are provided and the ratchet wheels 62 are each mounted to a respective rail 7 and extend forwardly toward a respective link 8.

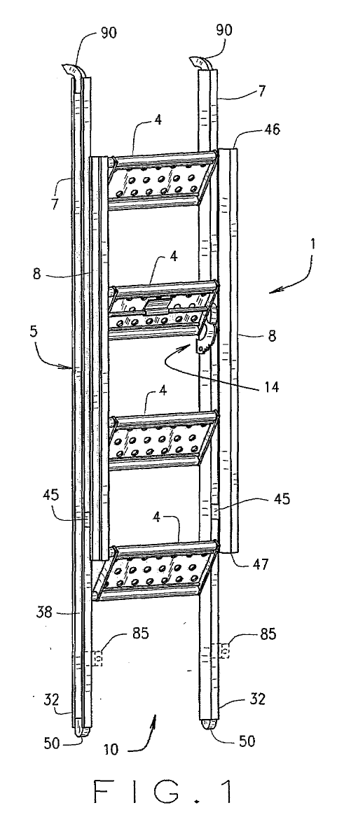

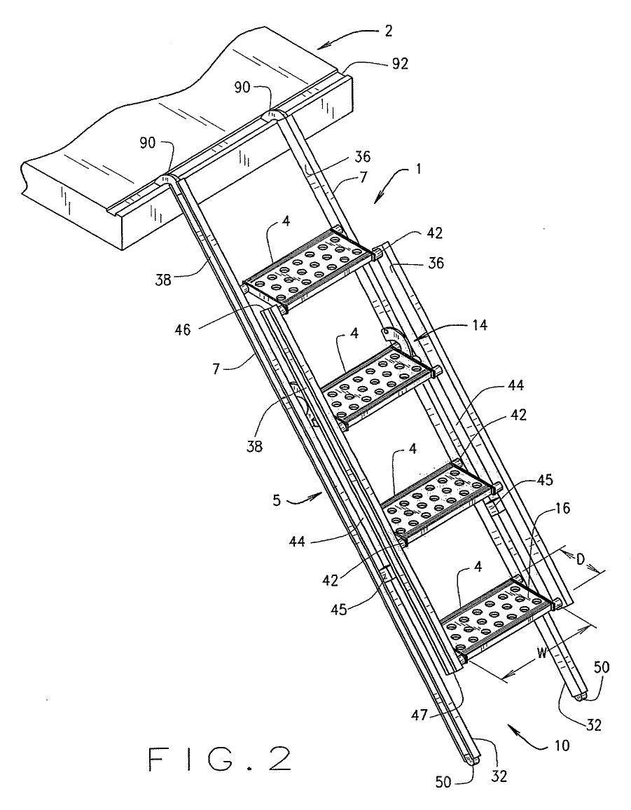

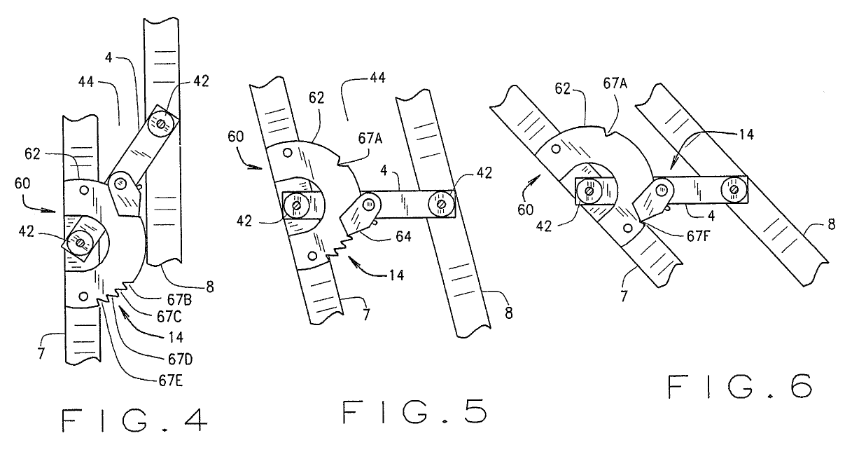

The ratchet mechanism 60 further includes a pawl 64 that is preferably biased, as for example, by being spring loaded, for engagement with a respective ratchet wheel 62. The pawl 64 includes a catch portion 72 adapted to fit within a notch 67 on the ratchet wheel 62. In the illustrated structure, the biasing is done by a torsion coil spring 75 having one end 76 engaging the pawl and one end 77 engaging a bottom side of the tread plate 16. Preload in the spring 75 biases the pawl 64 toward and into engagement with the ratchet wheel such that the catch portion 72 engages the peripheral edge 66 of the ratchet wheel 62 and is engagable within a selected notch 67. Preferably, the pawls 64 are fixed to a common shaft 79 to effect simultaneous movement of each pawl for release from a respective notch 67. As shown, a release device 81, such as a lever, is mounted or affixed to the shaft 79 as by set screws 83 to effect rotation thereof and pivoting movement of each of the pawls 64. The shaft 79 is pivotally mounted to a step 4 and the release 81 is positioned under the tread 16. The release 81 works against the preload of the spring 75 whereby upon release of the lever 81, via user release, the pawls 64 each move back into engagement with a respective ratchet wheel 62. As shown, each ratchet wheel 62 has a plurality of peripherally spaced apart notches 67. The notches are designated 67A-E respectively for convenience. The notch 67A, when the pawl is received therein, will lock the links 8 and the steps 4 in a collapsed configuration (FIGS. 1, 4) for storage of the ladder 1. The notches 67 B-E may be used to releasably lock the ladder 1 in a preselected extended configuration (FIGS. 2, 5, 6) for use. The notches 67B-E will allow user to select a desired pitch to adjust for the spacing between the ground on which the ladder will rest and the platform to which the ladder will provide steps to, for example, the interior of a truck, a loading dock or the like. The configuration of the notches 67 and the teeth 63 forming some of the notches is such as to permit free movement from the extended configuration to the collapsed configuration until the pawls 64 are received in a respective notch A which will lock the ladder and its component parts in the collapsed configuration. The notches 67 are also configured to selectively lock the ladder from moving from one extended position to a more downward extended position i.e., a one way ratchet. If the pitch is too high i.e., the steps are sloping downward and inwardly, the pawls 64 may be released from a respective notch 67 to allow the steps to be lowered on their free end. In use, it is more convenient to extend the ladder to its fully extended position and then move the steps upwardly until the desired step pitch is achieved. The pawls 64 are visible to allow a user to ensure that both of the pawls 64 are latched into a respective notch 67 indicating that the ladder 1 is ready to use.

As shown, the links 8 do not touch the ground during use and serve to effect simultaneous movement of the steps 4 when either a link 8 is moved or a step 4 is moved by a user. However, in an alternative embodiment, it is to be understood that the links 8 may contact the ground if desired when in an extended position. This would be particularly useful for ladders that are to be used on relatively flat and level ground surfaces e.g., a paved parking lot. In another alternate embodiment, the ratchet mechanisms 60 may be eliminated, and a fixed stop structure 85 (seen in phantom in FIG. 1) may be used as the stop mechanism 14 to limit movement of the links 8 and steps 4 to an extended or use configuration. Further, a plurality of such stop structures 85 may be used to provide for a variety of pitches for the steps. As seen in FIG. 1, the alternate stop structure 85 is shown as having one stop member on each rail 7. As shown, a stop member 85 is secured to each of the rails 7 and is engagable with a lower end of a respective link 8 when the links are moved from a collapsed configuration to an extended configuration limiting further movement of the links and fixing the pitch of the steps. The pitch of the steps 4 may be adjusted somewhat by the angle of the ladder when it is leaned against a device such as a truck bed for loading.

As best seen in FIGS. 1, 2, the ladder 1 is provided with a securement structure to releasably secure the ladder to the device providing the elevated loading or work surface or storage area. As shown, one or both of the rails 7 may be provided with a hook 90 which can be received within a groove 92 to releasably fix the upper portion of the ladder to the vehicle or the like. The ladder 1 may also be provided with an attached landing (not shown) which may be pivotally mounted to one or both of the rails and suitably constructed for limiting upward movement of the free ends of the landing relative to the rails 7 say, for example, an included angle between the landing and the rails of up to about 120 degrees and preferably more than 90 degrees.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A ladder with adjustable step pitch comprising
a plurality of steps;
a support structure having at least one back rail connected to the steps in a manner permitting pivoting movement of the steps relative to the back rail and a base for engaging the ground and spanning a distance of at least about one-half the width of a step, said support structure including a link associated with the steps to selectively effect simultaneous movement therebetween; and
a stop mechanism operably associated with at least one of the link and the steps to selectively limit movement of the steps relative to the at least one back rail to fix the pitch of the steps at a desired pitch relative to the at least one back rail.

2. The ladder of claim 1 wherein the stop mechanism including at least one ratchet mechanism associated with at least one said back rail and at least one said step to selectively fix the pitch of the steps relative to the at least one said back rail.

3. The ladder of claim 2 wherein the ratchet mechanism including a ratchet wheel portion and a pawl, said ratchet wheel portion being mounted to a said back rail or a said step and the pawl being mounted to the other of a said back rail or a said step.

4. The ladder of claim 2 wherein the at least one said back rail including a pair of said back rails each having a ground engaging end portion forming at least a portion of said base, said back rails being in laterally spaced apart relationship with the steps being pivotally suspended therebetween.

5. The ladder of claim 4 wherein the at least one ratchet mechanism including a pair of said ratchet mechanisms each associated with a respective said back rail and operable to selectively lock a respective side of a step at a desired pitch.

6. The ladder of claim 4 wherein said at least one link including a pair of said links, said links being in laterally spaced apart relationship with the steps being pivotally mounted to both of said links, said rail and link on a respective side of the steps forming a parallelogram connection arrangement.

7. The ladder of claim 4 wherein the steps being selectively movable between an extended configuration for use and a collapsed configuration for storage and including a spacer operably associated with a said rail and a respective said link to provide a space therebetween when the steps are in the collapsed configuration.

8. The ladder of claim 7 wherein the ratchet mechanism being operable to releasably secure the steps in the collapsed configuration.

9. The ladder of claim 8 wherein the ratchet mechanism being operable to releasably stop movement of the steps when moving in a direction from collapsed toward extended and operable to provide free movement in a direction from extended toward collapsed.

10. The ladder of claim 9 wherein the ratchet mechanism including a ratchet wheel portion and a pawl, said pawl normally engaging the ratchet wheel to limit movement of the steps in a direction from collapsed to extended and when selectively out of engagement with the ratchet wheel, permitting movement in the direction of collapsed to extended.

11. The ladder of claim 10 wherein the ratchet mechanism providing a plurality of fixed pitch positions for the steps.

12. The ladder of claim 1 wherein the stop mechanism including at least one stop member cooperating with the back rail and link limiting the movement of the link away from the back rail and thereby setting the pitch of the steps when the steps are in an extended configuration.

13. The ladder of claim 1 the at least one said back rail including a pair of said back rails each having a ground engaging end portion forming at least a portion of said base, said back rails being in laterally spaced apart relationship with the steps being pivotally suspended therebetween.

14. The ladder of claim 13 wherein including a pair of said links, said links being in laterally spaced apart relationship with the steps being pivotally mounted to both of said links, said rail and link on a respective side of the steps forming a parallelogram connection arrangement.

15. The ladder of claim 14 wherein the stop mechanism including a stop member cooperating with each said back rail and respective link to limit movement of the steps to an extended configuration.

16. The ladder of claim 15 wherein the at least one stop member including a plurality of said stop members cooperating with a respective said back rail and respective link to provide a plurality of fixed extended positions.
